(19) United States
(12) Patent Application Publication
(10) Pub. No.: US 2007/0209346 A1
(43) Pub. Date: Sep. 13, 2007

(54) Combined weed whacker, blower and vacuum apparatus

(76) Inventors: Peter J. Bovo, Columbus, NJ (US); Karen M. Bovo, Columbus, NJ (US)

Correspondence Address: Charles I. Brodsky, 2 Bucks Lane, Marlboro, NJ, 07746, US

(21) Appl. No.: 11/502,109

(22) Filed: Aug. 11, 2006

Related U.S. Application Data
(60) Provisional application No. 60/781,562, filed on Mar. 13, 2006.

(51) Int. Cl. A01D 46/00

(52) U.S. Cl. 56/12.8

(57) ABSTRACT

A housing which encloses the trimmer of a combined weed whacker, blower and vacuum to prevent grass and weeds from dispersal once cut so as to capture them after a trimming action by dropping them where they can easily be vacuumed into a container bag.

### CROSS-REFERENCE TO RELATED APPLICATIONS

A Provisional Patent Application covering the invention described herein was filed Mar. 13, 2006, and assigned Ser. No. 60/781,562.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to portable, hand-holdable trimmer devices for lawn and garden use, in general, and to a hand-holdable trimmer device which combines the functions of trimming, vacuuming and blowing in a configuration attractive for use about swimming pool areas, in particular.

2. Description of the Related Art

As is well known and understood, “grass” is a simple plant which will take over an area once a good environment is created for it. Unmown, grass grows a few feet tall, blooms in the late summer, and spreads its seeds in the autumn, to sprout in the spring. As is additionally known, grass also sends out runners which sprout new plants. As most grasses are perennial, they come back from year to year—although some do actually die of old age, needing to be reseeded every few years. Seeding, furthermore, is a fast way to grow new grass plants.

As generally accepted, the annoyance of having to hand cut grass in unmowable areas led to the development of the Weed Whacker in 1971—and from there, the many different types of weed trimmers on the market today. In deciding which one to purchase, three factors are generally considered: 1) power—making certain that the trimmer is powerful enough to handle the toughest job; 2) size—a trimmer having an adjustable neck so that it will fit the shortest and tallest of users; and 3) price—what can be reasonably spent in choosing the best trimmer for one's purposes and needs. Whether a buyer goes forward in purchasing a gas operated trimmer or an electric one, these same considerations of “power”, “size” and “price” come into play in the purchase of leaf blowers.

Electric leaf blowers, cordless electric leaf blowers, gas-powered blowers and gas-powered backpack blowers are also recognized as one of the green thumb user's most powerful tools. While gas-powered blowers are the more powerful unit, the electric ones are quieter. Mixing oil and gasoline operates the gas-powered leaf blower, while 2-stroke gasoline engines generally use the power backpack blower. In electric-powered leaf blowers, an electric motor drives the fan, so that these blowers require an electrical power source provided from an electrical outlet through an extension cord. For smaller lawn areas, the rechargeable battery operated unit can be used, in accordance with the limited operating time available. The air volume each type of all these blowers puts out needs to be checked for its ability to do the job at hand.

As will be appreciated, the hand held leaf blowers are the most popular among homeowners, mainly because of convenience and portable size; the backpack leaf blowers are used more often by professionals, and are mostly gas-powered; the backpack leaf blowers are typically used, and are most suitable for, larger areas. Wheeled or walk-behind leaf blowers are accepted as the best for maintaining large areas, and are preferred by professional and commercial users.

As will be understood, several models of leaf blowers are designed to operate in reverse, vacuuming leaves into a bag rather than blowing them away.

U.S. Pat. No. 5,862,595, on the other hand, describes a hand-holdable trimmer which incorporates a vacuum system for collecting the trimmer cuttings of grass into a convenient collection container mounted on the apparatus. In doing so, the disclosure describes that when using grass or weed trimmers, the cuttings are usually dispersed over a relatively wide area because of the high rotation speed of the filament head. As the disclosure sets out, it would be extremely advantageous if a grass or weed trimmer also incorporated means for sucking up the grass cuttings immediately after they were produced by the cutting head, and for storing the cuttings in a container carried with the trimmer. The patent asserts the elimination of the extra step of gathering the dispersed cuttings.

### SUMMARY OF THE INVENTION

As will become clear from the following description, the present invention differs from that of U.S. Pat. No. 5,862,595 in at least two very important respects. First, it combines in a single apparatus the additional function of leaf blowing. Second, it adds an enclosure about the rotating trimmer head to reduce the propensity for grass cuttings to disperse outwardly because of the high rotation speeds of the filament lines. Such restriction is particularly useful in the employment of the apparatus as a grass or weed trimmer in the area of in-ground swimming pools. Experience has shown that when trimming around the pool, the grass clippings tend to fly into the pool due to an insufficient vacuuming capability of the design. This is even more so where the gardening tool is of the more general configuration, without the vacuum feature combined with the trimmer.

### BRIEF DESCRIPTION OF THE DRAWING

These and other features of the present invention will be more clearly understood from a consideration of the following description, taken in connection with the single FIGURE of the drawing, in which:

FIG. 1 is an illustration helpful in an understanding of the combined weed whacker, blower and vacuum apparatus of the invention.

### DETAILED DESCRIPTION OF THE INVENTION

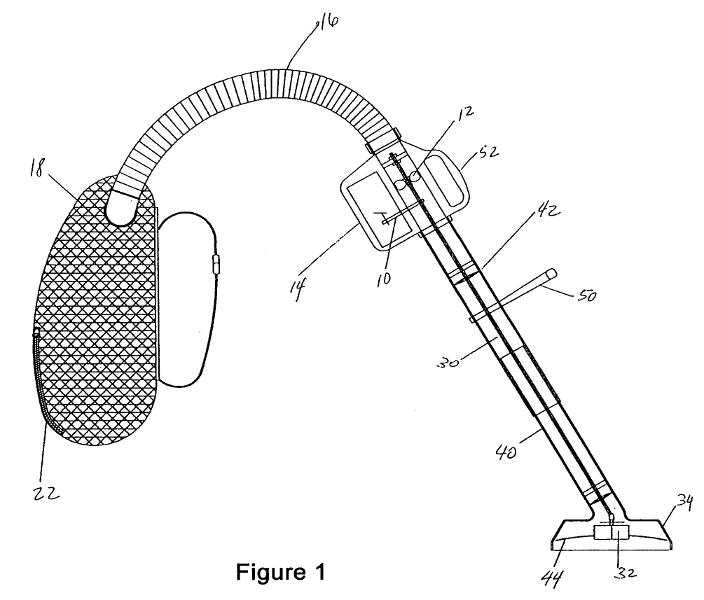

In the FIG. 1 apparatus, the blower and vacuum fan 10, mulching blade or impeller 12, and operating components are enclosed within a housing 14. The housing 14 is, in turn, connected by an accordion hose 16 to a catcher bag 18 openable by a zipper or like closure 22 for disposing of collected leaves or grass clippings sucked up by vacuum action. An edger rod or shaft 30, joined with a trimmer head 32, couples through the mulching blade 12 to join with the motor unit 10 for rotation in clipping the grass or weeds in places where it is difficult to mow. A second housing or enclosure 34 surrounds the trimmer head 32 to prevent outward dispersal of the clippings to the surrounding area, and restricts the flying of the clippings in any direction other than “up” or “down”. A pair of nested tubes 40, 42 surround the rod 30 in coupling to the housing 14, and are grasped by the user via a handle 50 on the tube 42. A second handle 52 on the housing 14 is similarly grasped, and includes the on-off switch for a battery operated hand held unit. (As will be appreciated by those skilled in the art, similar controls for a gas-powered unit or an electric-powered unit could be located adjacent the handle 52, as well.)

As FIG. 1 illustrates, the enclosure 34 is part of the lower tube 40, which can be removed by an easy twist-action from the upper tube 42. The tube 42 can likewise be twist-removed from the housing 14 to allow for the easy changing of a filament line 44 from off the trimmer head 32 as needed. At the same time, the edger rod 30 could be disconnected from the fan so that the tubes 40, 42 could then be recoupled to the housing 14 to allow the apparatus to operate either as a leaf blower or leaf vacuum by conventional switch control. As will be recognized by the skilled artisan, the enclosure 34 about the trimmer head 32 directs any cut grass or weeds to fall exactly beneath the trimmer head 32 in place, and allows them to be easily sucked up the tubes 40, 42 to the impeller blade 12 when the vacuum control of the apparatus is set. This limits any tendency for the grass or weed cuttings to fly about to contaminate an in-ground pool or patio area—and then having to be later vacuumed away.

With the reversible fan controls, with the separable tube couplings, and with the trimmer head enclosure, the apparatus of the invention allows for its use in the blowing, vacuuming, and mulching of leaves, and in the cutting and vacuuming of grass and weeds while limiting their annoying dispersal to adjacent areas.

In essence, then, the apparatus of the invention includes the housing 14, which has a first end and an opposite second end to which the accordion hose and catcher bag are connected when the apparatus is being used for trimming or vacuuming—or which can be disconnected when the apparatus of the invention is to be used for leaf blowing simply by reversing an apparatus switch on the housing 14, disengaging the hose 16 from the catcher bag 18 and using the disengaged hose 16 for the blowing. The housing then has a defining first end, with a passage extending between that end opening and the opposed second end. A drive motor mounted with the housing will be understood to be in communication with the passage for actuating the impeller blade. As will be appreciated by the skilled artisan, the operating components within the housing 14 couple to the drive motor to produce the appropriate rotation of the impeller.

The nested tubes 40, 42 encircle the drive shaft 30 and are hollowed to allow air flow upwardly, in allowing the vacuuming action or blowing action to proceed—which, in the latter event, with the disengaged hose from the bag 18, obviates any need for separating the trimmer head 32 and the shaft 30. The lower nested tube shows the second housing enclosing the side exhaust ports of the trimmer head for directing any cut grass or weeds to fall beneath the head, in preventing it from flying about into an adjacent swimming pool, or other areas where it is desired to keep clear of any grass or weeds.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

We claim:

1. A combined trimmer and vacuum apparatus for use in cutting grass or weeds, comprising:
a first housing having a first end, an opposed second end, and a passage extending therebetween;
a drive motor mounted with said first housing in communication with said passage;
an impeller mounted within said first housing;
a trimmer head assembly;
a drive shaft between said drive motor and said trimmer head assembly;
means within said first housing to rotate said impeller, and causing air to flow through said passage from said first housing end to said second housing end;
a hose connected at a first end to said second end of said first housing such that air flowing through said passage flows through said hose;
a first tube surrounding said drive shaft;
a second housing enclosing side exhaust ports of said trimmer head assembly at a first end of said first tube;
a second tube surrounding said drive shaft having a first end coupled with said first housing and coupled with a second end of said first tube;
with said side enclosing exhaust ports of said second housing being positioned to direct substantially all grass or weeds cut when said trimmer head assembly is rotating beneath said assembly.

2. The apparatus of claim 1, including a graspable handle on said first housing and a graspable handle on said second tube.

3. The apparatus of claim 2, also including a container coupled to a second end of said hose for collecting grass or weeks cut by said trimmer assembly.

4. The apparatus of claim 2 wherein said hose is of a sturdiness to be grasped adjacent to a second end thereof and held to utilize said air flow through said passage and hose to blow away leaf and cut grass accumulations.
